(19) United States
(12) Patent Application Publication
(10) Pub. No.: US 2020/0019903 A1
(43) Pub. Date: Jan. 16, 2020

(54) TOUR OPERATIONS PREDICTIVE RISK MANAGEMENT

(71) Applicant: Royal Caribbean Cruises Ltd., Miami, FL (US)

(72) Inventors: Sol Rashidi, Miami Beach, FL (US); Arya Eskamani, Miami, FL (US); Gracie Diaz, Coral Gables, FL (US)

(21) Appl. No.: 16/036,031

(22) Filed: Jul. 16, 2018

(51) Int. Cl. G06Q 10/06; G06K 9/62; G06Q 50/14

(52) U.S. Cl. CPC G06Q 10/0635; G06Q 50/14; G06K 9/6267

(57) ABSTRACT

A method for predicting risk in a tour operation includes first ingesting into memory of a computing system, textual observations from past tour operations and then correlating the textual observations to a corresponding one of the past tour operations. Thereafter, each of the past tour operations may be classified according to risk to personal safety and each correlation and an associated risk may be stored in an index. Consequently, tour commentary of a contemporaneously offered tour may be later loaded into memory of the computing system, and the terms of the tour commentary matched to the textual observations of at least one of the past tour operations. Finally, an associated risk is retrieved for an entry in the index corresponding to the at least one of the past tour operations, a predicted risk is computed based upon the retrieved risk value, and the predicted risk is displayed in a display of the computing system in connection with the contemporaneously offered tour.

### BACKGROUND OF THE INVENTION

### Field of the Invention

The present invention relates to the field of risk assessment and more particularly to predicting risk in third party excursions.

### Description of the Related Art

Conventional leisure travel generally includes traveling some distance to one or more destinations and visiting one or more sights of interest at each of the destinations. For many travelers, an overnight stay is expected at each destination from which the local sights may be visited. To the extent that many travelers are unaware of local sights of interest at a particular destination, oftentimes travelers defer to the expertise of the hotel—namely the concierge. In this instance, the concierge provides advice as to local sights to be visited and, optionally, third-party tour operators able to provide tours for requesting travelers to specified or even unspecified points of interest. Of course, some third-party tour operators are more reputable than others. Indeed, while most third-party tour operators have proven reliable and safe, others have proven less trustworthy.

For some excursions, the consequence of an untrustworthy tour operator is at most an inconvenienced or dissatisfied guest of the hotel. But, for other types of excursions, an untrustworthy tour operator can place the safety and well-being of a hotel guest into jeopardy. As such, most hotel concierge services carefully vet the local tour operators to ensure that the hotel concierge only recommends historically trustworthy tour operators to its guests. The hotel concierge is able to do so since there are only so many operators within proximity of the hotel which inherently, can be stationary geographically speaking. However, not all hotels are stationary geographically speaking. In the regard, the modern cruise ship often is viewed as a mobile hotel, transporting its guests from destination to destination over a fixed period of time.

In the case of a modern cruise ship, a multiplicity of different ports often are scheduled for visits. At each port of call, passengers may disembark the ship and seek out local sights of interest. To facilitate passenger excursions, third-party tour operators provide marketing materials to the crew of the ship for dissemination to the passengers of the ship and to make the crew aware of the availability of tourism services provided by the third-party tour operators. Given the large number of ports of call for the different ships of the different cruise lines, accounting for the trustworthiness and untrustworthiness of each third-party tour operator can be challenging if not impossible. Conventionally, the cruise line simply relies upon the imperfect personal knowledge of the crew in order to adjudge the relative safety of the multiplicity of tour operators and excursions available to the passengers of the cruise line.

### BRIEF SUMMARY OF THE INVENTION

Embodiments of the present invention address deficiencies of the art in respect to risk assessment for third-party tour operators and provide a novel and non-obvious method, system and computer program product for predicting risk in a tour operation. In an embodiment of the invention, a method for predicting risk in a tour operation includes first ingesting into memory of a computing system, textual observations from past tour operations, such as text from an operator log or text from guest commentary, and then correlating the textual observations to a corresponding one of the past tour operations. Thereafter, each of the past tour operations may be classified according to risk to personal safety and each correlation and an associated risk may be stored in an index. Consequently, tour commentary of a contemporaneously offered tour may be later loaded into memory of the computing system, and terms of the tour commentary matched to the terms of the textual observations of at least one of the past tour operations. Finally, an associated risk is retrieved for an entry in the index corresponding to the at least one of the past tour operations, a predicted risk is computed based upon the retrieved associated risk value, and the predicted risk is displayed in a display of the computing system in connection with the contemporaneously offered tour.

In an aspect of the embodiment, the predicted risk is a composition of different risk values in the index for each of the past tour operations with textual observations including one or more of the terms. In another aspect of the embodiment, a frequency may be tabulated of each of the terms matched to textual observations of the past tour operations for which a high predicted risk has been assigned in the index. Thereafter, the matched terms in the tabulation may be displayed in a portion of a user interface of the computing system. As well, a number of textual observations may be tabulated that had been received for each of the past tour operations for which a high predicted risk has been assigned in the index, and a list of the past tour operations in the tabulation then displayed in a portion of a user interface of the computing system.

In another embodiment of the invention, a data processing system may be configured for predicting risk in a tour operation. The system includes a host computing system having at least one processor and memory and a data store coupled to the system. The data stores different text files, each referring to textual observations of a multiplicity of past tour operations, the data store additionally storing an index correlating each one of the textual observations with a corresponding one of the past tour operations, and an associated risk to personal safety for the corresponding one of the past tour operations.

The module includes computer program instructions that during execution in the memory load into memory of the computing system, tour commentary of a contemporaneously offered tour, match terms of the tour commentary to terms of the textual observations of at least one of the past tour operations, retrieve an associated risk value for an entry in the index corresponding to the at least one past tour operations, compute a predicted risk based upon the retrieved associated risk value and display the predicted risk in a display of the host computing system in connection with the contemporaneously offered tour.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for predicting risk in a tour operation;

FIG. 2 is a schematic diagram of a data processing system configured for predicting risk in a tour operation; and,

FIGS. 3A and 3B, taken together, are a flow chart illustrating a process for predicting risk in a tour operation.

### DETAILED DESCRIPTION OF THE INVENTION

Embodiments of the invention provide for the prediction of risk in a tour operation. In accordance with an embodiment of the invention, textual observations are received upon submission to a computing system in respect to past tour operations. The textual observations for each specific past tour operation is then correlated to a one of the past tour operations, while each of the past tour operations is classified according to risk to personal safety. Each correlation and associated risk is then stored in an index. Thereafter, tour commentary pertaining to a contemporaneously offered tour may be loaded into memory of the computing system and the text of the tour commentary parsed to identify terms present in the textual observations of the past tour operations so as to best match the tour commentary of the contemporaneously offered tour with one of the textual observations of the past tour operations. As such, an associated risk is retrieved for an entry in the index for the matched one of the past tour operations and the risk is displayed in a display of the computing system in connection with the contemporaneously offered tour.

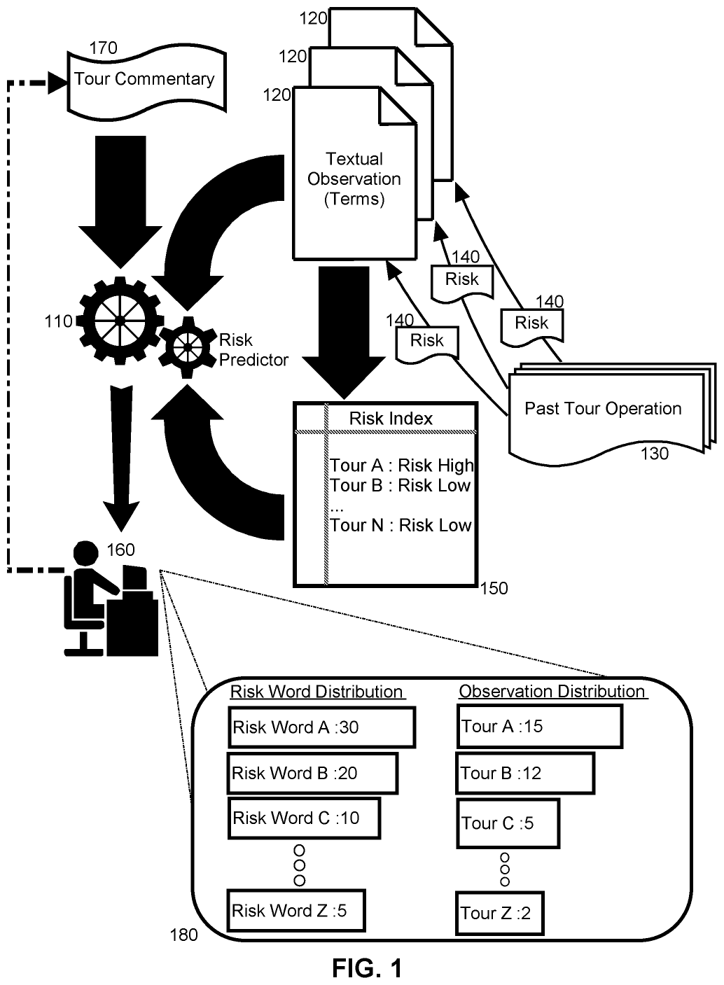

In further illustration, FIG. 1 pictorially depicts a process for predicting risk in a tour operation. As shown in FIG. 1, risk predictor 110 parses the textual observations 120 corresponding to different past tour operations 130 with associated risk values 140 so as to generate a correlation between different terms of the textual observations 120 and the risk values 140 associated with correspondingly different ones of the past tour operations 130. The correlations between the terms in the textual observations 120 and the past tour operations 130 and the assigned risk values 140 are then stored in a risk index 150. In this way, the risk index 150 may be queried with one or more terms so that the terms of the query may be matched to terms in the risk index 150 and a corresponding one or more of the risk values 140 retrieved.

Thereafter, end user 160 provides tour commentary 170 corresponding to a contemporaneously offered tour to the risk predictor 110. The risk predictor 110 compares the terms of the tour commentary 170 to terms in the risk index 150 so as to match the terms to corresponding ones of the past tour operations 130. As such, the risk predictor 110 retrieves from the risk index 150 one or more corresponding risk values assigned to corresponding matching ones of the past tour operations 130. The risk predictor 110 then calculates a predicted risk for the contemporaneously offered tour based upon the retrieved risk values 140, for example as an average of the retrieved risk values 140, or as the one of the retrieved risk values 140 corresponding to one of the past tour operations 130 with the most matching terms of an associated textual observation 120, or as a maximum of the retrieved risk values 140, or a sum of the retrieved risk values 140.

Finally, the risk predictor 110 displays the predicted risk of the proposed tour to the end user 160 in a user interface 180 to the risk predictor 110. In this regard, the user interface 180 also can include a portion rendering a distribution of the terms in the textual observations 120 so that terms most frequently appearing in the textual observations 120 for ones of the past tour operations 130 considered to be of threshold risk are presented for viewing in the user interface 180 for the benefit of the end user 160. As well, the user interface 180 also includes a portion rendering a distribution of the past tour operations 130 in order of a frequency of observations 120 provided for the respective ones of the past tour operations 130.

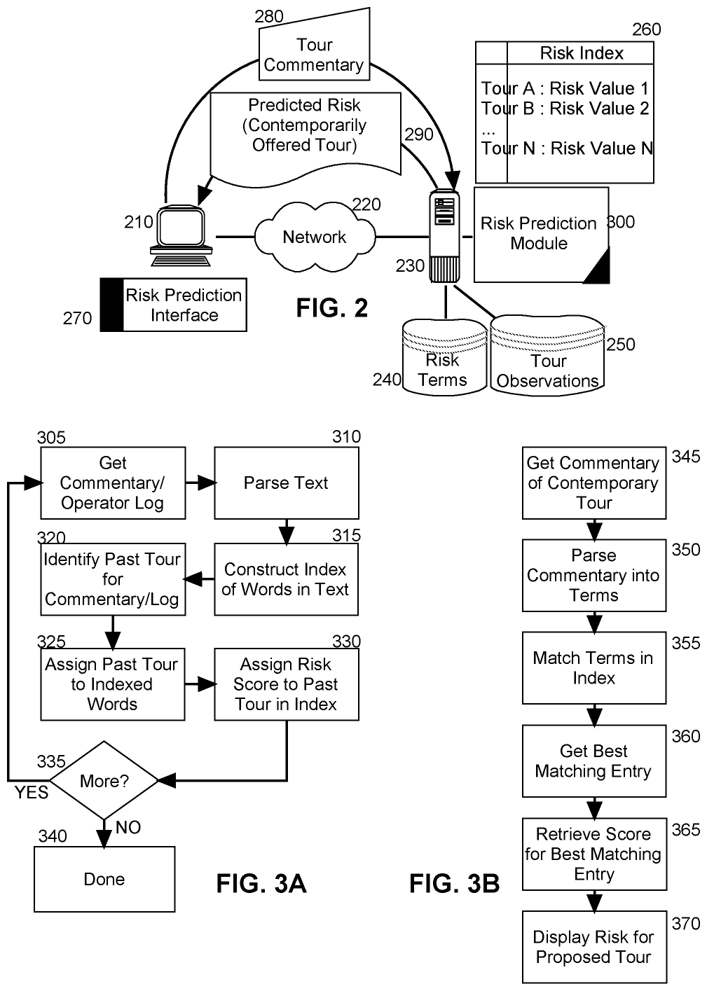

The process described in connection with FIG. 1 may be implemented in a data processing system. In yet further illustration, FIG. 2 schematically shows a data processing system configured for predicting risk in a tour operation. The system includes a client computer 210 coupled to a server computer 230 over computer communications network 220. A database of risk terms 240 and a database of tour observations 250 are coupled to the server 230. The database of tour observations 250 stores therein textual observations for corresponding past tour operations, each of the tour observations having a singular association with one of the past tour operations. The database of risk terms 240 in turn stores therein textual terms present in corresponding ones of the textual observations 250 of the past tour operations.

More particularly, textual observations for past tour operations are pre-labeled according to one or more different risk classifications as containing a set measure of risk-indicative material, for instance “determined risk”, “potential risk” and “low risk”. As well, meta-data is associated with each of the textual observations and includes a corresponding guest, if any, providing the textual observation, an itinerary of the voyage for which the observation pertains, port departures for the voyage and excursion purchases for the guest. Each textual observation may be loaded into memory and subjected to pre-processing, including a standardization process in which special characters, numbers, and punctuations are removed and all text is converted to lower-case characters. The pre-processing also includes tokenization during which each word is dissected into a unique entity to be analyzed independently within each text record, part of speech tagging during which each token has imprinted thereon its designated place in the structure of a corresponding sentence such as verb, noun, adjective, possessive, etc., lemmatization in which each tokenized word is broken down into its root or lemma based on a corresponding part of speech, and stopword removal in which a basket of frequently used but irrelevant words are removed, both in standard and domain-specific vernacular, so as to reduce the frequency of inconsequential information being processed by the algorithm

Once the body of text for a textual observation has been standardized, the standardized body of text may be converted into a numerical format commensurate with consumption by a model, namely into a sparse-matrix where for every record containing a commentary:
Each word or combination of words (in the case of N-grams), hereinafter a risk term, is placed into a column as an input, such that the sparse-matrix contains a column for every unique risk term.
The value corresponding to the record-column intersection represents the relative frequency of that risk term in the body of text.
If the risk term is not present in the body of text, the risk term retains a value of zero in the record-column intersection
   The transformed body of text is then ingested by a machine learning algorithm to build relationships between which risk terms and computed relevant frequencies, whether individually or in concert with other risk terms, map to specific the specific risk classifications.

Returning now to FIG. 2, a risk prediction module 300 includes computer program instructions and executes by a processor in the memory of the server 230. The computer program instructions process each of the tour observations in the database of tour observations 250 to identify a presence and frequency of different terms in the database of risk terms 240 in each of the different tour observations in the database 250. The computer program instructions further process each of the tour observations in in the database of tour observations 250 to identify a corresponding one of the past tours in the database of past tours 240 to which the tour observations in the database of tour observations 250 apply. The computer program instructions yet further correlate each of the tour observations in the database of tour observations with a risk value assigned to a corresponding one of the past tours in a risk index 260.

A risk prediction interface 270 is presented in a display of the client computer 210. The risk prediction interface 270 provides a user interface to the risk prediction module 300 and receives therein tour commentary 280 of a contemporaneously offered tour 280. The computer program instructions parse the textual elements of the tour commentary 280 to locate different ones of the past tours associated in the risk index 260 having associated tour observations in the database of tour observations 250 with common terms in the database of risk terms 240. The computer program instructions then retrieve from the risk index 260 a corresponding risk value for each of the matching one of the past tours. The computer program instructions then compute a predicted risk from the retrieved risk values as a predicted risk of the contemporaneously offered tour for display in the risk prediction interface 270.

In even yet further illustration of the operation of the risk prediction module 300, FIGS. 3A and 3B, taken together, are a flow chart illustrating a process for predicting risk in a tour operation. Beginning in block 305 of FIG. 3A, the module loads from fixed storage, commentary or an operator log associated with a past tour and in block 310, the module parses the text of the commentary or operator log. In block 315, the module constructs an index of words in the parsed text and in block 320, the module identifies a past tour associated with the parsed text, for example through meta-data provided with the commentary or operator log, and in block 325, the past tour is associated with the indexed words. Then, in block 330, the module assigns a risk value to the identified past tour, either based upon a composition of other risk scores for other commentary or operator logs pertaining to the past tour or based upon the aggregate number and frequency of risk words present in all commentary and operator logs pertaining to the identified past tour, or by manual assignment. In decision block 335, if additional commentary or operator logs remain to be parsed, the process repeats through block 305. Otherwise the process ends in block 340.

Turning now to FIG. 3B, once the risk index has been constructed, in block 345 the module receives through a corresponding user interface, textual commentary of a contemporaneously offered tour. In block 350, the module parses the textual description of the contemporaneously offered tour and matches terms of the textual description to risk words in the index in block 355 so as to identify different past tour operations associated with different tour observations also including the same risk words. In block 360, the module determines one or more best matching entries for one or more past tour operations and in block 365, the module retrieves a risk value for each best matching entry from the risk index. Finally, in block 370 the module calculates a predicted risk from the retrieved risk values and the module displays the predicted risk as the predicted risk to personal safety for the contemporaneously offered tour thus accounting for the trustworthiness and untrustworthiness of each third-party tour operator without relying upon the imperfect personal knowledge of the crew in order to adjudge the relative safety of a multiplicity of tour operators and excursions available to the passengers of the cruise line.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for predicting risk in a tour operation comprising:
ingesting into memory of a computing system, textual observations from past tour operations and correlating the textual observations to a corresponding one of the past tour operations;
classifying each of the past tour operations according to risk to personal safety;
storing each correlation and an associated risk in an index;
loading into memory of the computing system, tour commentary of a contemporaneously offered tour;
matching terms of the tour commentary to terms of the textual observations of at least one of the past tour operations;
retrieving an associated risk value for an entry in the index corresponding to the at least one past tour operation;
computing a predicted risk based upon the retrieved associated risk value; and,
displaying the predicted risk in a display of the computing system in connection with the contemporaneously offered tour.

2. The method of claim 1, wherein the textual observations of the past tour operations each are guest commentary for a corresponding one of the one or more of the past tour operations.

3. The method of claim 1, wherein the textual observations of the past tour operations each are textual observations from an operator log of a corresponding one of the one or more of the past tour operations.

4. The method of claim 1, wherein the predicted risk is a composition of different risk values in the index for each of the past tour operations with textual observations including one or more of the terms.

5. The method of claim 1, further comprising:
tabulating a frequency of each of the terms matched to textual observations of the past tour operations for which a high predicted risk has been assigned in the index; and,
displaying the matched terms in the tabulation in a portion of a user interface of the computing system.

6. The method of claim 1, further comprising:
tabulating a number of textual observations received for each of the past tour operations for which a high predicted risk has been assigned in the index; and,
displaying a list of the past tour operations in the tabulation in a portion of a user interface of the computing system.

7. A data processing system configured for predicting risk in a tour operation, the system comprising:
a host computing system comprising at least one processor and memory;
a data store coupled to the system and storing therein different text files, each referring to textual observations of a multiplicity of past tour operations, the data store additionally storing an index correlating each one of the textual observations with a corresponding one of the past tour operations, and an associated risk to personal safety for the corresponding one of the past tour operations; and,
a tour risk prediction module executing in the memory of the host computing system, the module comprising computer program instructions that during execution in the memory load into memory of the computing system, tour commentary of a contemporaneously offered tour, match terms of the tour commentary to terms of the textual observations of at least one of the past tour operations, retrieve an associated risk value for an entry in the index corresponding to the at least one past tour operations, compute a predicted risk based upon the retrieved associated risk value and display the predicted risk in a display of the host computing system in connection with the contemporaneously offered tour.

8. The system of claim 1, wherein the textual observations of the past tour operations each are guest commentary for a corresponding one of the one or more of the past tour operations.

9. The system of claim 7, wherein the textual observations of the past tour operations each are textual observations from an operator log of a corresponding of the one or more of the past tour operations.

10. The system of claim 7, wherein the predicted risk is a composition of different risk values in the index for each of the past tour operations with textual observations including one or more of the terms.

11. The system of claim 7, wherein the computer program instructions during execution in the memory further perform:
tabulating a frequency of each of the terms matched to textual observations of the past tour operations for which a high predicted risk has been assigned in the index; and,
displaying the matched terms in the tabulation in a portion of a user interface of the computing system.

12. The system of claim 7, wherein the computer program instructions during execution in the memory further perform:
tabulating a number of textual observations received for each of the past tour operations for which a high predicted risk has been assigned in the index; and,
displaying a list of the past tour operations in the tabulation in a portion of a user interface of the computing system.

13. A computer program product for predicting risk in a tour operation, the computer program product including a computer readable storage medium having program instructions embodied therewith, the program instructions executable by a device to cause the device to perform a method including:
ingesting into memory of a computing system, textual observations from past tour operations and correlating the textual observations to a corresponding one of the past tour operations;
classifying each of the past tour operations according to risk to personal safety;
storing each correlation and an associated risk in an index;
loading into memory of the computing system, tour commentary of a contemporaneously offered tour;
matching terms of the tour commentary to terms of the textual observations of at least one of the past tour operations;
retrieving an associated risk value for an entry in the index corresponding to the at least one past tour operation;
computing a predicted risk based upon the retrieved associated risk value; and,
displaying the predicted risk in a display of the computing system in connection with the contemporaneously offered tour.

14. The computer program product of claim 13, wherein the textual observations of the past tour operations each are guest commentary for a corresponding one of the one or more of the past tour operations.

15. The computer program product of claim 13, wherein the textual observations of the past tour operations each are textual observations from an operator log of a corresponding one of the one or more of the past tour operations.

16. The computer program product of claim 13, wherein the predicted risk is a composition of different risk values in the index for each of the past tour operations with textual observations including one or more of the terms.

17. The computer program product of claim 13, wherein the method further comprises:
tabulating a frequency of each of the terms matched to textual observations of the past tour operations for which a high predicted risk has been assigned in the index; and,
displaying the matched terms in the tabulation in a portion of a user interface of the computing system.

18. The computer program product of claim 13, wherein the method further comprises:
tabulating a number of textual observations received for each of the past tour operations for which a high predicted risk has been assigned in the index; and,
displaying a list of the past tour operations in the tabulation in a portion of a user interface of the computing system.
